(19) United States
(12) Patent Application Publication
(10) Pub. No.: US 2020/0373711 A1
(43) Pub. Date: Nov. 26, 2020

(54) CONNECTOR AND WIRE HARNESS

(71) Applicants: YAZAKI CORPORATION, Tokyo (JP); HONDA MOTOR CO., LTD., Tokyo (JP)

(72) Inventors: Tomoyuki Miyakawa, Utsunomiya-shi (JP); Kozo Oishi, Utsunomiya-shi (JP); Kazuyuki Ochiai, Asaka-shi (JP); Daisuke Fujihira, Asaka-shi (JP); Shintaro Matsuda, Asaka-shi (JP)

(21) Appl. No.: 16/882,396

(22) Filed: May 22, 2020

(30) Foreign Application Priority Data
May 24, 2019 (JP) 2019-097911

(51) Int. Cl. H01R 13/641; H01R 13/639; H01R 13/422; H01R 13/24; H01R 13/33

(52) U.S. Cl. CPC H01R 13/641; H01R 13/639; H01R 13/33; H01R 13/2435; H01R 13/4223

(57) ABSTRACT

A connector includes: a housing; and a detector detecting whether a terminal is received at a regular position. The locking portion has an abutment part to lock the terminal, and an interference part interfering with the detector to prevent the detector from being assembled to the housing. The abutment part is displaced to lock the terminal at the regular position when the terminal is at the regular position, and to leave the terminal when the terminal is not at the regular position. The interference part moves along with the abutment part to a position not to interfere with the detector when the terminal is at the regular position, and to be displaced to a position to interfere with the detector when terminal is not at the regular position.

### CROSS-REFERENCES TO RELATED APPLICATION(S)

This application is based on and claims priority from Japanese Patent Application No. 2019-097911 filed on May 24, 2019, and the entire contents of which are incorporated herein by reference.

### BACKGROUND

### Field of the Invention

The present invention relates to a connector including a housing having a locking portion by which a terminal to be received in a terminal housing chamber is locked at a regular position, and a detector which detects whether the terminal is received at the regular position or not, and a wire harness using the connector.

### Description of Related Art

A connector including a detector (such as a front holder) for detecting whether a terminal is received at a regular position in a terminal housing chamber or not has been proposed. For example, in one of connectors in the background art, a front holder is mounted in a housing so that the front holder can move in a preset fitting direction between a temporary locking position and a permanent locking position. The front holder is arranged so that the front holder can move to the permanent locking position when a terminal is at a regular position (hereinafter also referred to as “regular insertion position”), and the front holder cannot move to the permanent locking position when the terminal is at a half-insertion position. Thus, in the connector in the background art, whether the terminal is received at the regular position or not (to say other words, whether the terminal is in a half-insertion state or not) can be detected based on the fact that the front holder cannot move to the permanent locking position when the terminal is at the half-insertion position.

As for details of the above connector, refer to JP 5,933,380 B and JP 5,599,300 B.

### SUMMARY

In a typical connector provided with such a detector, a locking portion (such as a lance) for locking a terminal into a terminal housing chamber is pushed out to the outside of the terminal housing chamber during the insertion process of the terminal, and the detector (such as a front holder) is brought into contact with the locking portion so as to prevent the detector from moving to the permanent locking position. To say other words, the locking portion (lance) for locking the terminal also has a function of regulating the movement of the detector (front holder). The structure in which the locking portion has a plurality of functions in this manner is advantageous in terms of miniaturization of the connector, and so on. On the other hand, shapes required for various functions respectively have to be integrated in a single locking portion. Therefore, the degree of freedom in designing the locking portion tends to be lowered.

For example, when the size of the locking portion (lance) is increased in order to enhance accuracy in detecting the half-insertion state of the terminal, the rigidity of the locking portion, or the like, is increased so that the work of receiving the terminal into the terminal housing chamber may be difficult. In addition, the size of the locking portion also depends on the size of the terminal. In fact, it is also not easy to increase the size of the locking portion itself. On the contrary, when the size of the locking portion is reduced in order to facilitate the work of receiving the terminal, the strength of the locking portion is lowered. Thus, in spite of the half-insertion state of the terminal, the detector (front holder) may push the locking portion aside and move to the permanent locking position so as to lower the accuracy in detecting the half-insertion state of the terminal.

An object of the invention is to provide a connector capable of compatibly attaining workability in receiving a terminal into a terminal housing chamber, and high detection accuracy in detecting a half-insertion state of the terminal, and a wire harness using the connector.

Embodiments of the present invention provide the following items [1] to [5].
[1] A connector comprising:

a housing having a terminal housing chamber and a locking portion to lock a terminal at a preset regular position; and

a detector detecting whether or not the terminal being received at the regular position upon the detector being be assembled to the housing,

the locking portion having an abutment part abutting against the terminal to lock the terminal, and an interference part interfering with the detector to prevent the detector from being assembled to the housing,

the abutment part being displaced to abut against the terminal to lock the terminal at the regular position upon the terminal being at the regular position, and to leave the terminal upon the terminal not being at the regular position,

the interference part moving along with a displacement of the abutment part and being configured to be displaced at a position not to interfere with the detector upon the terminal being at the regular position, and to be displaced to a position to interfere with the detector upon the terminal not being at the regular position.
[2] The connector according to the item [1], wherein

the housing has a plurality of the terminal housing chambers; and

the locking portion provided in at least one of the terminal housing chambers has the interference part.
[3] The connector according to the item [1] or the item [2], wherein

the locking portion has a double-supported-beam-shaped elastically deformable support part extending in a direction to a terminal housing direction and the abutment part and the interference part disposed to move along with the support part.
[4] The connector according to any one of the item to the item [3], wherein

the housing has a plurality of the terminal housing chambers,

the connector further comprises a short-circuit terminal configured to contact two or more the terminals housed in two or more of the plurality of terminal housing chambers to electrically short the two or more the terminals,

the locking portion each provided in the two or more of the terminal housing chambers has the abutment part and the interference part.
[5] A wire harness comprising:

the connector according to any one of the item [1] to the item [4]; and

an electric wire configured to have the terminal housed in the terminal housing chamber.

According to first aspect of the invention, relating to the item [1], the locking portion of the housing includes the abutment part (such as a tip of a lance) that locks the terminal, and the interference part (such as a rib or a protrusion) that interferes with the detector (such as a front holder). Thus, the abutment part and the interference part can be designed independently of each other so that the degrees of freedom in designing the two parts can be increased. For example, the abutment part can be designed to have a shape making it easy to receive the terminal into the terminal housing chamber, while the interference part can be designed to have large size or high strength enough to surely prevent the detector from being assembled. Accordingly, the connector having this configuration can compatibly attain workability in receiving the terminal into the terminal housing chamber and high detection accuracy in detecting a half-insertion state of the terminal.

According to second aspect of the invention, relating to the item [2], the interference part that interferes with the detector is provided in the locking portion of at least one of the terminal housing chambers. Accordingly, the housing can be manufactured easily to reduce the manufacturing cost of the connector, in comparison with a case where interference parts are provided in locking portions of all terminal housing chambers respectively.

According to third aspect of the invention, relating to the item [3], the locking portion has a shape like a double-supported beam. The locking portion like a double-supported beam has enhanced strength as a beam in comparison with a locking portion like a cantilever beam. Thus, the locking portion can lock the terminal more firmly. However, the locking portion like a double-supported beam does not have a free end like a locking portion shaped like a cantilever beam. Thus, the locking portion cannot prevent the detector from moving by a tip face of the free end abutting against the detector. Therefore, the detector may push the beam aside to thereby slide to the permanent locking position even if the terminal is not at the regular position. In this manner, the locking portion shaped like a double-supported beam can indeed lock the terminal firmly, but cannot easily enhance the accuracy in detecting the half-insertion state of the terminal, in comparison with a locking portion like a cantilever beam. However, in the connector having this configuration, the abutment part and the interference part can be designed to be shaped and disposed suitably to each of functions. It is therefore possible to further enhance the accuracy in detecting the half-insertion state of the terminal without spoiling the advantage that the terminal can be locked firmly, in comparison with a case where the locking portion has a shape like a double-supported beam simply.

According to fourth aspect of the invention, relating to the item [4], the short-circuit terminal is provided in the housing. With respect to this point, a connector having a short-circuit terminal for electrically short-circuiting specified terminals with each other in order to prevent unintended current conduction between the terminals or the like has been proposed in the background art (for example, see Japanese Patent No. 5599300). In such a connector in the background art, the short-circuit terminal is often assembled near the permanent locking position of the detector. As a result, in the structure of the connector in the background art, it is difficult to compatibly attain workability in receiving a terminal into a terminal housing chamber, and high detection accuracy in detecting a half-insertion state of the terminal. However, in the connector having this configuration, the abutment part for locking a terminal and the interference part for detecting a half-insertion state of the terminal can be designed independently of each other. Thus, even when a short-circuit terminal is provided in the housing, it is possible to compatibly attain workability in receiving a terminal into a terminal housing chamber and high detection accuracy in detecting a half-insertion state of the terminal.

According to fifth aspect of the invention, relating to the item [5], the locking portion of the housing includes the abutment part (such as a tip of a lance) that locks the terminal, and the interference part (such as a rib or a protrusion) that interferes with the detector (such as a front holder). Thus, the abutment part and the interference part can be designed independently of each other so that the degrees of freedom in designing the two parts can be increased. For example, the abutment part can be designed to have a shape making it easy to receive the terminal into the terminal housing chamber, while the interference part can be designed to have large size or high strength enough to surely prevent the detector from being assembled. Accordingly, when the connector configured thus is used, the half-insertion state of the terminal can be detected properly so that the quality of the wire harness can be enhanced.

In this manner, according to the present invention, it is possible to provide a connector capable of compatibly attaining workability in receiving a terminal into a terminal housing chamber, and high detection accuracy in detecting a half-insertion state of the terminal, and a wire harness using the connector.

The present invention has been described briefly above. The further details of the invention will be made clearer if embodiments for carrying out the invention in the following description are read through with reference to the accompanying drawings.

### BRIEF DESCRIPTION OF THE DRAWINGS

FIG. 1 is an exploded perspective view of a connector according to an embodiment of the present invention;

FIG. 2 is a perspective view of the connector according to the embodiment of the invention;

FIG. 3A is a perspective view of the connector to which a front holder has not been attached yet, and FIG. 3B is a perspective view of a section A-A in FIG. 3A;

FIG. 4 is a perspective view of a short-circuit terminal shown in FIG. 1;

FIG. 5A is a perspective view of a front holder shown in FIG. 1, FIG. 5B is a perspective view of a section B-B in FIG. 5A, and FIG. 5C is a perspective view of a section C-C in FIG. 5A;

FIG. 6A is a front view of the connector shown in FIG. 2, and FIG. 6B is an enlarged view of a portion in FIG. 6A;

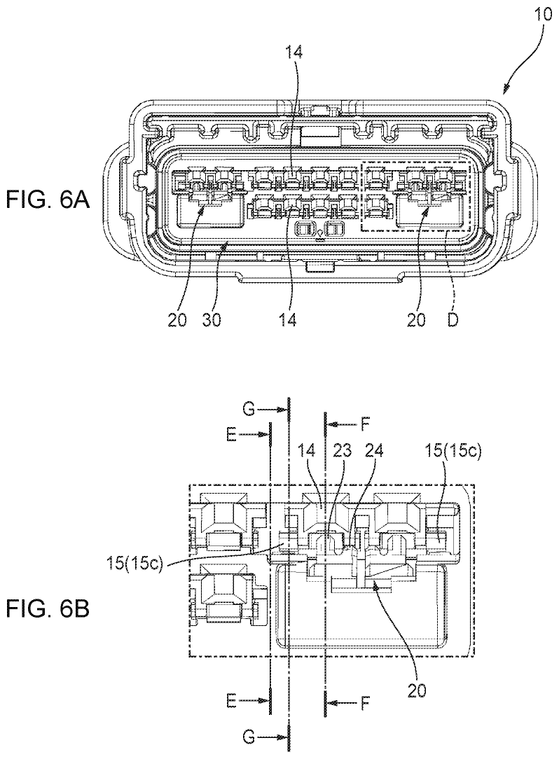

FIG. 7A is a perspective view of a section E-E in FIG. 6B in which a to-be-short-circuited terminal has not been inserted, and FIG. 7B is an enlarged view of a portion H in FIG. 7A;

FIG. 8A is a sectional view taken on line F-F in FIG. 6B in which the to-be-short-circuited terminal is at a middle-insertion position, and FIG. 8B is a sectional view taken on line F-F in FIG. 6B in which the to-be-short-circuited terminal is at a regular insertion position;

FIG. 9A is a sectional view taken on line G-G in FIG. 6B in which the to-be-short-circuited terminal is at the middle-insertion position, and FIG. 9B is a sectional view taken on line G-G in FIG. 6B in which the to-be-short-circuited terminal is at the regular insertion position; and

FIG. 10A and FIG. 10B are views corresponding to FIG. 7B according to modifications.

### DETAILED DESCRIPTION

### Embodiment

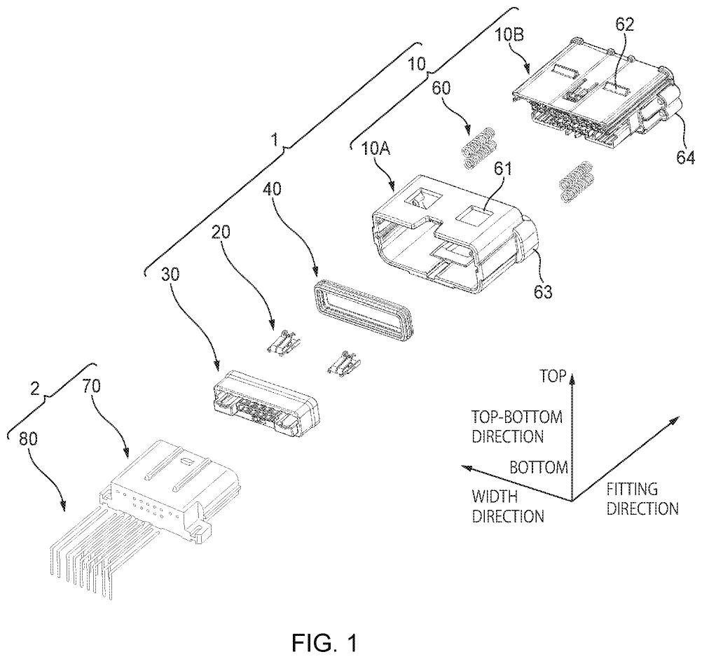

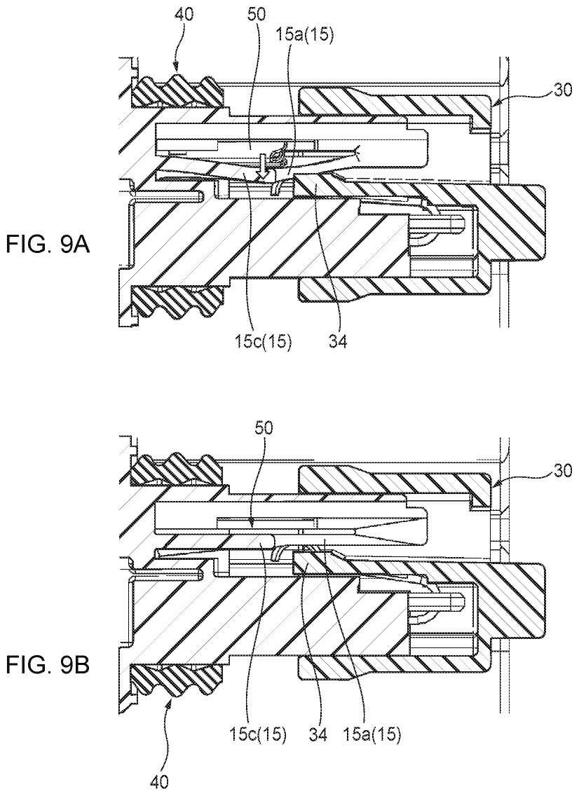

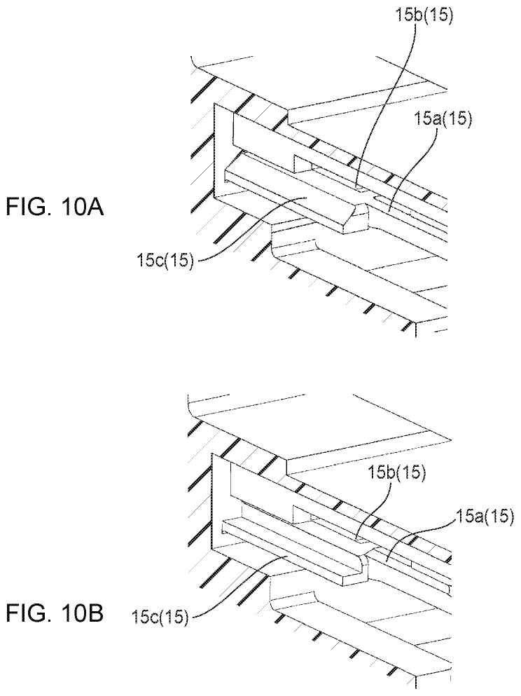

A connector 1 and a wire harness using the connector 1 according to an embodiment of the present invention will be described below with reference to the drawings. As shown in FIG. 1, a housing 10 of the connector 1 can be fitted to a mating housing 70 of a mating connector 2. When the connector 1 (housing 10) is fitted to the mating connector 2 (mating connector 70), a terminal (female terminal) 50 (see FIGS. 9A and 9B and FIGS. 10A and 10B) received in the housing 10 is electrically connected to a mating terminal (male terminal) 80 received in the mating housing 70 so that an electric wire (not shown) connected to the terminal 50 is electrically connected to an electric wire (not shown) connected to the mating terminal 80.

For the sake of convenience for explanation, in the following description, a “fitting direction”, a “width direction”, an “up/down direction”, “upper” and “lower” are defined as shown in FIG. 1. The “fitting direction”, the “width direction” and the “up/down direction” cross one another at right angles. The fitting direction coincides with a direction in which the connector 1 is fitted to the mating connector 2. In the connector 1, the front side in the fitting direction where the mating connector 2 is fitted is regarded as “front” side, and the back side opposite thereto in the fitting direction is regarded as “rear” side.

As shown in FIG. 1, the connector 1 is configured to include the housing 10, a pair of short-circuit terminals 20 attached to the housing 10, and a front holder 30 attached to the housing 10. The configurations of those components constituting the connector 1 will be described in turn below.

First, the housing 10 will be described. As shown in FIG. 1, the housing 10 is constituted by an outer housing 10A made of resin, an inner housing 10B made of resin, and a plurality (four in this embodiment) of springs 60 made of metal. A locking protrusion 62 of the inner housing 10B is locked to a locking hole 61 of the outer housing 10A in a state where the springs 60 are held (compressed) in the fitting direction by spring holding portions 63 on the outer housing 10A side and spring holding portions 64 on the inner housing 10B side against the elastic force of the springs 60. Thus, the housing 10 is completely assembled.

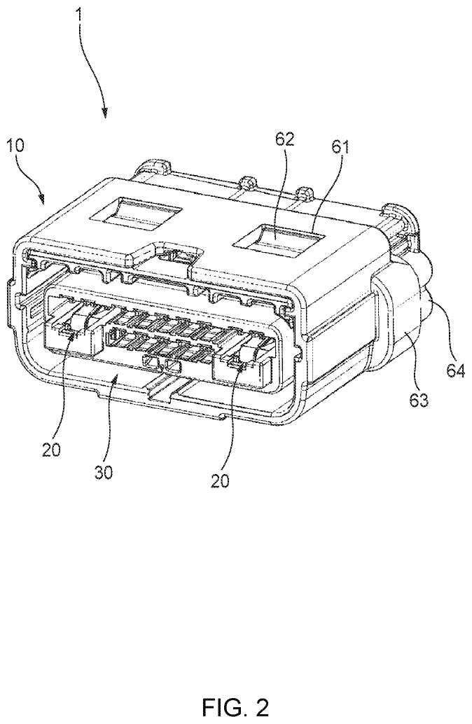

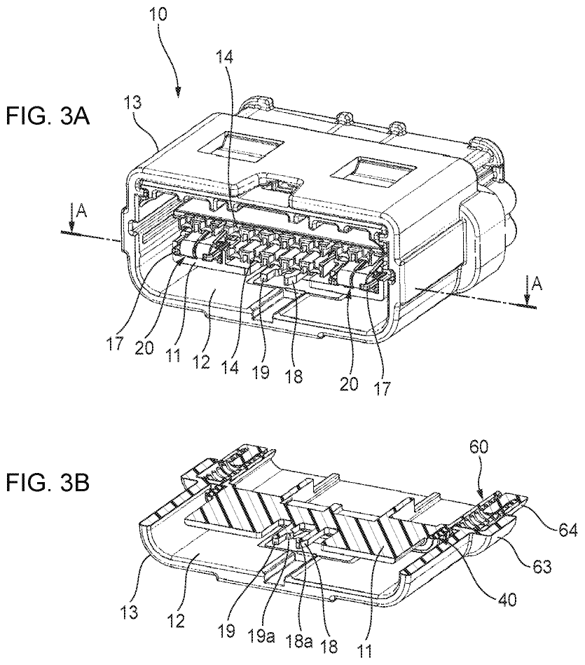

As shown in FIG. 2 and FIGS. 3A and 3B, the housing 10 has a terminal reception portion 11 having an approximately rectangular parallelepiped shape and formed by the inner housing 10B, and an outer cylindrical portion 13 having an approximately angular cylindrical shape and constituted by the outer housing 10A. The outer circumference of the terminal reception portion 11 is covered with the outer cylindrical portion 13 through an annular gap 12 opened to the front side. The annular gap 12 functions as a space to which a frame portion 31 (which will be describe later in detail) of the front holder 30 is inserted when the front holder 30 is attached.

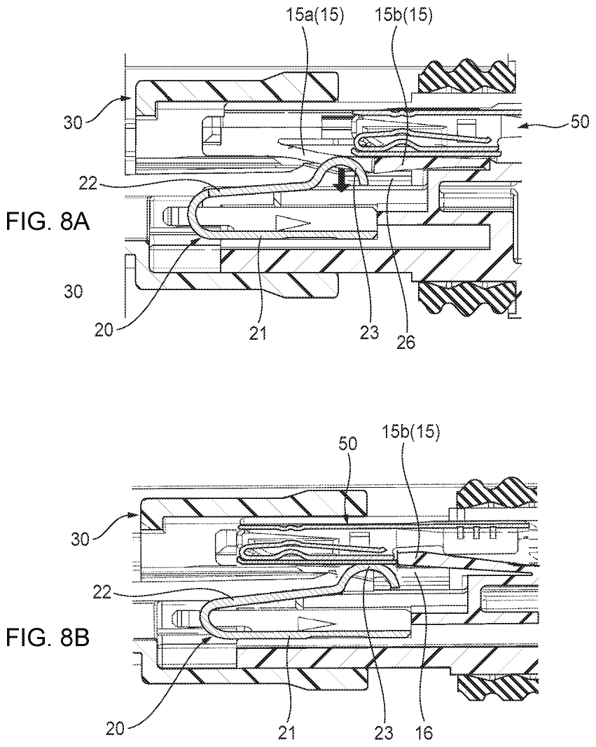

In the terminal reception portion 11, as shown in FIG. 3A, terminal housing chambers 14 for receiving terminals 50 (see FIGS. 8A and 8B and FIGS. 9A and 9B) are formed to extend in the fitting direction. In this embodiment, a plurality of terminal housing chambers 14 are provided to be arranged side by side in the width direction in two upper and lower stages. Specifically, five terminal housing chambers 14 are provided in the lower stage so as to be arranged side by side in the width direction in a central region of the terminal reception portion 11 excluding opposite end parts thereof in the width direction, and nine terminal housing chambers 14 are provided in the upper stage so as to be arranged side by side in the width direction almost all over the region of the terminal reception portion 11 in the width direction.

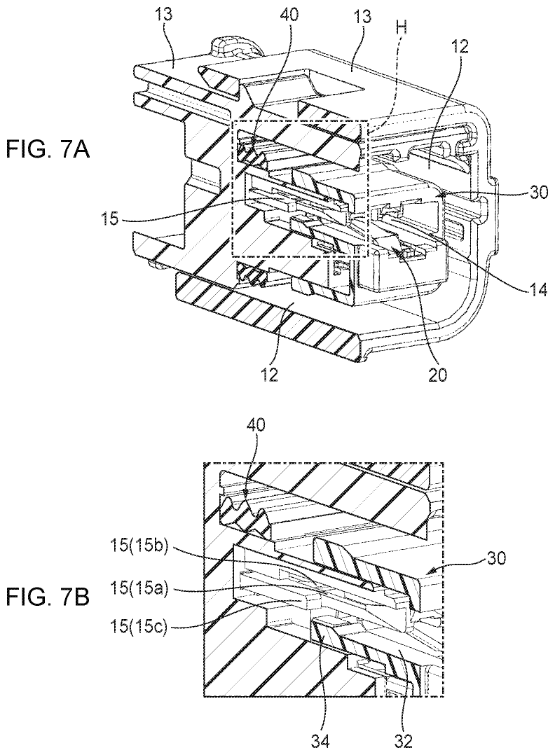

A locking portion 15 is provided in each terminal housing chamber 14 so as to face the terminal housing chamber 14 from the lower side and at a substantially center position in the fitting direction as shown in FIGS. 7A and 7B, FIGS. 8A and 8B and FIGS. 9A and 9B. In this embodiment, as shown in FIG. 7B, the locking portion 15 has a pair of double-supported beam portions 15a disposed to be arranged side by side in the width direction, and a lance portion 15b positioned between the pair of double-supported beam portions 15a and provided integrally with the pair of double-supported beam portions 15a.

The double-supported beam portions 15a are double-supported beam-like parts extending in the fitting direction, and parts deformable in the up/down direction (parts showing an elastically bending function). The lance portion 15b interlocks with the up/down motion of the double-supported beam portions 15a. In addition, in a state where the double-supported beam portions 15a are not elastically deformed (a state shown in FIG. 8A), the lance portion 15b extends to allow the tip end side thereof to enter slightly into the terminal housing chamber 14 and to be inclined upward. The lance portion 15b locks, to the tip end thereof, a preset corner portion of the terminal 50 inserted from the rear side into the terminal housing chamber 14. That is, the lance portion 15b is a part showing a function of preventing the terminal 50 from falling out to the rear side (a part showing a locking function).

When the terminal 50 is at a regular insertion position in the terminal housing chamber 14 (in a state where the lance portion 15b shows the falling-out prevention function), the tip end of the lance portion 15b enters a corner portion of the terminal 50 so that the double-supported beam portions 15a and the lance portion 15b are kept in a state where they are not elastically deformed (posture shown in FIG. 7A, FIG. 7B, FIG. 8B and FIG. 9B, which will be hereinafter referred to as “original position”). When the lance portion 15b is in its original position, a detection portion 33 (which will be described in detail later) of the front holder 30 can be inserted into a space 16 (see FIG. 8B) facing a lower side face (a side face on the opposite side to the terminal housing chamber 14) of the lance portion 15b.

On the other hand, when the terminal 50 is at a half-insertion position (in a state where the lance portion 15b does not show the falling-out prevention function), the tip end of the lance portion 15b cannot enter the corner portion of the terminal 50. As a result, the double-supported beam portions 15a and the lance portion 15b are kept in the posture where they are elastically deformed downward (in a direction going away from the terminal housing chamber 14 (the posture shown in FIG. 8A and FIG. 9A). In this case, the detection portion 33 of the front holder 30 interferes with the tip end of the lance portion 15b elastically deformed downward, so that the detection portion 33 of the front holder 33 cannot enter the space 16.

As shown in FIG. 3A, a pair of short-circuit terminal mounting spaces 17 for mounting the pair of short-circuit terminals 20 therein are formed in width-direction opposite outside parts of the five terminal housing chambers 14 in the lower one of the two upper and lower stages. Each short-circuit terminal mounting space 17 communicates, in the up/down direction, with a front region of the lance portion 15b in a corresponding one of a pair of terminal housing chambers 14 disposed adjacently to width-direction opposite end portions of the nine terminal housing chambers 14 in the upper stage.

In the following description, for the sake of convenience for explanation, each of the pair of terminal housing chambers 14 communicating with the short-circuit terminal mounting spaces 17 in the up/down direction respectively may be referred to as “to-be-short-circuited terminal housing chamber 14” particularly, and the terminal 50 inserted into the “to-be-short-circuited terminal housing chamber 14 may be referred to as “to-be-short-circuited terminal 50” particularly. On the other hand, each terminal housing chamber 14 that is not a to-be-short-circuited terminal housing chamber 14 may be referred to as “regular terminal housing chamber 14”, and each terminal 50 that is not a to-be-short-circuited terminal 50 may be referred to as “regular terminal 50”.

As shown in FIG. 3A and FIG. 3B, a pair of cantilever beam-like elastic pieces 18 and 19 that are elastically deformable in the width direction are provided in the width-direction center portion of a lower portion of the terminal reception portion 11 so as to be arranged side by side in the width direction and to extend frontward. Protrusions 18a and 19a protruding inward in the width direction are formed in the pair of elastic pieces 18 and 19 respectively. The protrusions 18a and 19a have a function of locking the front holder 30 to a temporal locking position and a permanent locking position.

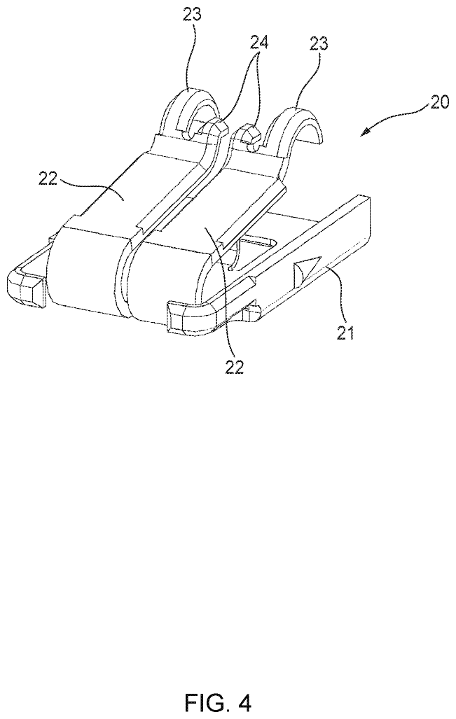

Next, the short-circuit terminals 20 will be described. As shown in FIG. 4, each short-circuit terminal 20 integrally has a pedestal portion 21 like a flat plate, and a pair of elastically deformable contact pieces 22 bent upward and extending rearward from a front end portion of the pedestal portion 21. The pair of contact pieces 22 are provided to be arranged side by side in the width direction. In a tip end portion (rear end portion) of each contact piece 22, a contact part 23 curved upward is formed at a width-direction outside position, and a pressed part 24 protruding upward slightly is formed at a width-direction inside position.

The short-circuit terminals 20 are inserted from the front into the pair of short-circuit terminal mounting spaces 17 of the housing 10 respectively, and mounted therein. In the state where the short-circuit terminals 20 are mounted in the short-circuit terminal mounting spaces 17, the pair of contact parts 23 touch the pair of to-be-short-circuited terminals 50 inserted into the pair of to-be-short-circuited terminal housing chambers 14 posited above the contact parts 23 respectively, so as to short-circuit the pair of to-be-short-circuited terminals 50 with each other (see FIG. 8B).

The pair of pressed parts 24 are positioned just under the double-supported beam portions 15a of the pair of to-be-short-circuited terminal housing chambers 14 positioned above the pressed parts 24, so as to be pressed downward by the double-supported beam portions 15a elastically deformed downward. Incidentally, this point will be described in detail later.

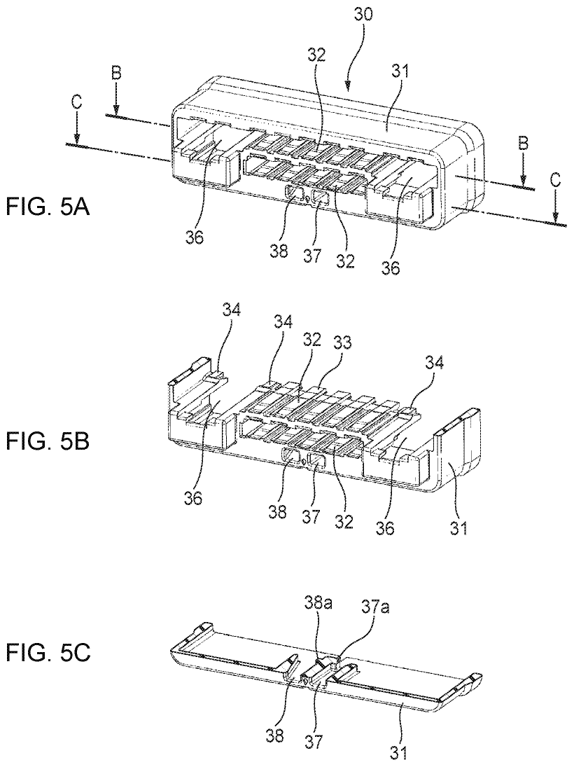

Next, the front holder 30 will be described. As shown in FIGS. 5A to 5C, the front holder 30 made of resin has an angular cylindrical frame portion 31. Inside the frame portion 31, detection plates 32 like flat plates are provided integrally with the frame portion 31 correspondingly to the terminal housing chambers 14 in the two upper and lower stages so as to extend rearward in the two upper and lower stages. Detection portions 33 (a total of 10) corresponding to the five regular terminal housing chambers 14 in the two upper and lower stages respectively are provided in rear end portions of the detection plates 43 in the two upper and lower stages.

A pair of openings 36 are provided at places corresponding to the pair of short-circuit terminal mounting spaces 17 in width-direction opposite end portions of the detection plates 32 in the upper stage so as to penetrate the detection plates 32. The openings 36 are provided not to impede the communication in the up/down direction between the short-circuit terminal mounting spaces 17 of the housing 10 and the pair of to-be-short-circuited terminal housing chambers 14 positioned above the short-circuit terminal mounting spaces 17 respectively in the state where the front holder 30 is mounted in the housing 10.

A pair of detection portions 34 (a total of four) corresponding to a corresponding one of the pair of to-be-short-circuited terminal housing chambers 14 are provided in rear end portions adjacent to width-direction opposite side edges of each opening 36 in the detection plates 32 in the upper stage. In this manner, the detection portions 34 are provided in positions not to impede the operation of the short-circuit terminals 20 when the short-circuit terminals 20 are mounted in the short-circuit terminal mounting spaces 17.

In a width-direction center portion of a lower portion of the front holder 30, a pair of through holes 37 and 38 penetrating the front holder 30 in the fitting direction are provided to be arranged side by side in the width direction, particularly as shown in FIG. 5C. Protrusions 37a and 38a protruding axially outward are formed in the pair of through holes 37 and 38 respectively. The protrusions 37a and 38a have a function of locking the front holder 30 at a temporary locking position and a permanent locking position (as will be described in detail later). The components constituting the connector 1 have been described above.

### <Mounting Front Holder 30 in Housing 10>

Next, operation for mounting the front holder 30 in the housing 10 will be described. First, as shown in FIGS. 7A and 7B etc., an angular cylindrical packing 40 made of rubber is inserted into the annular gap 12 of the housing 10 from the front side and fixed to a preset position of the outer circumference of the terminal reception portions 11. A plurality (three in this embodiment) of annular lip portions are formed in the outer circumferential face of the packing 40. The annular lip portions have a function of watertight sealing between the mating housing 70 and the housing 10 when the mating housing 70 (see FIG. 1) is fitted to the housing 10.

Next, as shown in FIG. 7A, the front holder 30 is inserted into the annular space 12 from the front side. On this occasion, the pair of elastic pieces 18 and 19 of the housing 10 are inserted into the through holes 37 and 38 of the front holder 30 respectively. When the insertion of the front holder 30 progresses, the protrusion 18a of the elastic piece 18 touches the protrusion 37a of the through hole 37.

After the protrusion 18a touches the protrusion 37a, the elastic piece 18 is elastically deformed outward in the width direction with the progress of the insertion so that the protrusion 18a rides on the protrusion 37a. After that, with the progress of the insertion, the protrusion 18a gets over the protrusion 37a so that the elastic piece 18 is elastically returned. Thus, the protrusion 18a and the protrusion 19a are engaged with the protrusion 37a and the protrusion 38a respectively in the state where the protrusion 18a is positioned on the front side of the protrusion 37a and the protrusion 19a is positioned on the rear side of the protrusion 38a, so that the front holder 30 is retained at the temporary locking position as shown in FIG. 7A.

When the regular terminal 50 is inserted into the regular terminal housing chamber 14 so as to reach the regular insertion position in this state, the lance portion 15b is retained at its original position (posture shown in FIG. 8B) as described above. Thus, the detection portion 33 (see FIG. 5B) of the front holder 30 can enter the space 16 (FIG. 8B). Due to the state obtained thus, when the front holder 30 at the temporary locking position is pushed rearward in the state where the regular terminal 50 is at the regular insertion position, the detection portion 33 enters the space 16 so that the front holder moves to the permanent locking position. On that occasion, the protrusion 19a of the elastic piece 19 getting over the protrusion 38a of the through hole 38 and positioned on the front side of the protrusion 38a is engaged with the protrusion 38a of the through hole 38 so that the front holder 30 is retained at the permanent locking position.

On the other hand, in the state where the regular terminal 40 is at the half-insertion position, the lance portion 15b is retained in the posture (see FIG. 8A) where the lance portion 15b is elastically deformed downward (in a direction leaving the terminal housing chamber 14) as described above. Thus, the tip end of the lance portion 15b and the detection portion 33 interfere with each other so that the detection portion 33 cannot enter the space 16. As a result, the front holder 30 cannot move from the temporary locking position to the permanent locking position. In this manner, the half-insertion of the regular terminal 50 can be detected easily based on the fact that the front holder 30 cannot move from the temporary locking position to the permanent locking position.

The operation about the temporary locking position and the permanent locking position of the front holder 30 described above is applied only to the relationship between the regular terminal 50 and the regular terminal housing chamber 14. The operation about the temporary locking position and the permanent locking position of the front holder 30 in the relationship between the to-be-short-circuited terminal 50 and the to-be-short-circuited terminal housing chamber 14 will be described later.

### <Pushing Down Short-Circuit Terminal 20 by Double-Supported Beam Portions 15a of Locking Portion 15>

Next, the operation that the short-circuit terminal 20 is pushed down by the double-supported beam portions 15a of the locking portion 15 will be described. As described above, the pressed parts 24 of the short-circuit terminal 20 are positioned just under the double-supported beam portions 15a of the to-be-short-circuited terminal housing chamber 14 positioned above the short-circuit terminal 20.

Thus, as shown in FIG. 8A and FIG. 9A, the double-supported beam portions 15a elastically deformed downward press the pressed parts 24 of the short-circuit terminal 20 downward when the double-supported beam portions 15a and the lance portion 15b are elastically deformed downward in a halfway stage to receive the to-be-short-circuited terminal 50 into the to-be-short-circuited terminal housing chamber 14. As a result, the pressed parts 24 (and hence the contact pieces 22) are pushed down (elastically deformed downward) interlocking with the double-supported beam portions 15a so that, as shown in FIG. 8A, the contact part 23 of the short-circuit terminal 20 also moves downward (see the black arrow in FIG. 8A). This operation will be referred to as “pushing down the short-circuit terminal 20 by the double-supported beam portions 15a” below.

When the insertion of the to-be-short-circuited terminal 50 further progresses in the state where “pushing down the short-circuit terminal 20 by the double-supported beam portions 15a” is kept, the front end portion of the to-be-short-circuited terminal 50 begins to touch the contact parts 23. After that, the to-be-short-circuited terminal 50 pushing down the contact parts 23 further downward rides on the contact parts 23 so that the insertion of the to-be-short-circuited terminal 50 further progresses while keeping the state where the contact parts 23 touch the to-be-short-circuited terminal 50. Then when the to-be-short-circuited terminal 50 reaches the regular insertion position of the to-be-short-circuited terminal housing chamber 14, the double-supported beam portions 15a and the lance portion 15b are elastically returned upward so as to return to their original positions (see FIG. 8B) in the state where the contact parts 23 are kept in touch with the to-be-short-circuited terminal 50.

Due to the aforementioned “pushing down the short-circuit terminal 20 by the double-supported beam portions 15a”, the pushing-down amount of the contact parts 23 pushed down by the to-be-short-circuited terminal 50 is reduced, and the contact angle of the terminal 50 with the contact parts 23 at the time when they begin to touch each other is also reduced. As a result, the terminal insertion force can be reduced.

### <Operation of Front Holder 30 in Relationship Between To-Be-Short-Circuited Terminal 50 and To-Be-Short-Circuited Terminal Housing Chamber 14>

In the embodiment, as shown in FIG. 7B, a rib portion 15c protruding integrally and outward in the width direction from the width-direction outside face of each double-supported beam portion 15a in the locking portion 15 provided in each to-be-short-circuited terminal housing chamber 14 of the terminal housing chambers 14. The rib portion 15c extends in the fitting direction along the double-supported beam portion 15a in a rear region of the double-supported beam portion 15a extending in the fitting direction. The rib portions 15c are provided in positions corresponding to the detection portions 34 (a total of four, see FIG. 5B) of the front holder 30 in the width direction respectively. In this manner, the lance portions 15b and the rib portions 15c are disposed in different places from each other in the connector 1.

As shown in FIG. 9A, in the state where the to-be-short-circuited terminal 50 is at the half-insertion position of the to-be-short-circuited terminal housing chamber 14, the double-supported beam portions 15a and the lance portion 15b are kept in the posture (see FIG. 8A) in which they are elastically deformed downward (in the direction leaving the terminal housing chamber 14). Accordingly, the rib portions 15c interlocking with the double-supported beam portions 15a and the lance portion 15b are also kept in a state where the rib portions 15c are displaced downward (in the direction leaving the terminal housing chamber 14). Thus, the front end faces of the rib portions 15c interfere with the detection portions 34 of the front holder 30 so that the detection portions 34 cannot enter more. As a result, the front holder 30 cannot move from the temporary locking position to the permanent locking position. In this manner, the half-insertion of the to-be-short-circuited terminal 50 can be detected easily based on the fact that the front holder 30 cannot move from the temporary locking position to the permanent locking position.

On the other hand, when the to-be-short-circuited terminal 50 is inserted up to the regular insertion position of the to-be-short-circuited terminal housing chamber 14 in this state, the double-supported beam portions 15a and the lance portion 15b are elastically returned (upward) to their original positions (the posture shown in FIG. 8B) as described above. Thus, as shown in FIG. 9B, the rib portions 15c interlocking with the double-supported beam portions 15a and the lance portion 15b are also returned to their original positions (moves upward). Therefore, the detection portions 34 of the front holder 30 can enter the regions under the rib portions 15c without interfering with the front end faces of the rib portions 15c. Due to the state obtained thus, when the front holder 30 at the temporary locking position is pushed rearward in the state where the to-be-short-circuited terminal 50 is at the regular insertion position, the detection portions 34 can enter the regions under the rib portions 15c while front holder 30 can move to the permanent locking position.

### <Operation/Effect>

According to the connector 1 and the wire harness using the connector 1 according to the embodiment of the present invention, the locking portion 15 of the housing 10 has the lance portion 15b for locking the terminal 50, and the rib portions 15c interfering with the detection portions 34 of the front holder 30. Thus, the lance portion 15b and the rib portions 15c can be designed independently of each other, so as to increase the degrees of freedom in designing those portions respectively. Particularly when the lance portion 15b and the rib portions 15c are disposed at different places from each other, the degrees of freedom in designing those portions can be further improved respectively. For example, the lance portion 15b can be designed to have a shape making it easy to receive the terminal 50 into the terminal housing chamber 14, while the rib portions 15c can be designed to have large size or high strength enough to surely prevent the front holder 30 from being assembled. Accordingly, the connector 1 configured thus can compatibly attain workability in receiving the terminal 50 into the terminal housing chamber 14 and high detection accuracy in detecting the half-insertion state of the terminal 50.

Further, according to the connector 1, the rib portions 15c that interfere with the detectors 34 of the front holder 30 are provided in only the locking portion 15 of at least each to-be-short-circuited terminal housing chambers 14 of the terminal housing chambers 14. Accordingly, the housing 10 can be manufactured easily to reduce the manufacturing cost of the connector 1, in comparison with a case where rib portions 15c are provided in locking portions 15 of all the terminal housing chambers 14 respectively.

### Other Embodiments

In addition, the invention is not limited to the aforementioned embodiments, but various modifications can be used within the scope of the invention. For example, the invention is not limited to the aforementioned embodiments, but changes, improvements, etc. can be made on the invention suitably. In addition, materials, shapes, dimensions, numbers, arrangement places, etc. of respective constituent elements in the aforementioned embodiments are not limited. Any materials, any shapes, any dimensions, any numbers, any arrangement places, etc. may be used as long as the invention can be attained.

In the aforementioned embodiment, the rib portions 15c interfering with the detection portions 34 of the front holder 30 are provided in only the locking portions 15 of the to-be-short-circuited terminal housing chambers 14 of the terminal housing chambers 14. However, the rib portions 15c may be also provided in any regular terminal housing chamber 14 of the terminal housing chambers 14.

Further, in the aforementioned embodiment, each locking portion 15 is constituted by a pair of double-supported beam portions 15a, a lance portion 15b positioned between the pair of double-supported beam portions 15a, and rib portions 15c protruding integrally and outward from the width-direction outside faces of the double-supported beam portions 15a, and the rib portions 15c interfere with the detection portions 34 of the front holder 30 so that the half-insertion state of the to-be-short-circuited terminal 50 can be detected. However, the locking portion 15 may have another form (for example, a form constituted by only a cantilever-like lance portion and a rib portion) as long as an interference part which is a part different from any abutment part in the locking portion 15 interferes with a detection portion 34 of the front holder 30 so that the half-insertion state of the to-be-short-circuited terminal 50 can be detected.

Further, in the aforementioned embodiment, the front holder 30 to be mounted in the housing 10 from the front side is used as a “detector”. However, a rear holder to be mounted in the housing 10 from the rear side may be used as a “detector”.

Further, the connector 1 according to the aforementioned embodiment can be used as a constituent component of a wire harness. More specifically, the connector 1 can be used in a wire harness constituting a circuit for operating an inflator of an air bag for a vehicle so as to prevent the inflator from malfunctioning due to static electricity or the like.

Here, the features of the embodiment of the aforementioned connector 1 and the wire harness according to the present invention will be summarized and listed briefly in the following paragraphs [1] to [5].
[1] A connector (1) comprising:

a housing (10) having a terminal housing chamber (14) and a locking portion (15) to lock a terminal (50) at a preset regular position; and

a detector (30) detecting whether or not the terminal (50) being received at the regular position upon the detector (30) being be assembled to the housing (10),

the locking portion (15) having an abutment part (15b) abutting against the terminal (50) to lock the terminal (50), and an interference part (15c) interfering with the detector (30) to prevent the detector (30) from being assembled to the housing (10),

the abutment part (15b) being displaced to abut against the terminal (50) to lock the terminal (50) at the regular position upon the terminal (50) being at the regular position, and to leave the terminal (50) upon the terminal (50) not being at the regular position,

the interference part (15c) moving along with a displacement of the abutment part (15b) and being configured to be displaced at a position not to interfere with the detector (30) upon the terminal (50) being at the regular position, and to be displaced to a position to interfere with the detector (30) upon the terminal (50) not being at the regular position.
[2] The connector (1) according to the tem [1], wherein

the housing (10) has a plurality of the terminal housing chambers (14), and

the locking portion (15) provided in at east one of the terminal housing chambers (14) has the interference part (15c),
[3] The connector (1) according to the item [1] or the item [2], wherein

the locking portion (15) has a double-supported-beam-shaped elastically deformable support part (15a) extending in a direction to a terminal (50) housing (10) direction and the abutment part (15b) and the interference part (15c) disposed to move along with the support part (15a).
[4] The connector (1) according to any one of the item [1] to the item [3], wherein

the housing (10) has a plurality of the terminal housing chambers (14),

the connector (1) further comprises a short-circuit terminal (50) configured to contact two or more the terminals (50) housed in two or more of the plurality of terminal housing chambers (14) to electrically short the two or more the terminals (50),

the locking portion (15) each provided in the two or more of the terminal housing chambers (14) has the abutment part (15b) and the interference part (15c).
[5] A wire harness comprising:

the connector (1) according to any one of the item [1] to the item [4]; and

an electric wire configured to have the terminal (50) housed in the terminal housing chamber (14).

### REFERENCE SIGNS LIST

1 connector
10 housing
14 terminal housing chamber
15 locking portion
15a double-supported beam portion (support part)
15b lance portion (abutment part)
15c rib portion (interference part)
20 short-circuit terminal
30 front holder (detector)
50 terminal

1. A connector comprising:
a housing having a terminal housing chamber and a locking portion to lock a terminal at a preset regular position; and
a detector detecting whether or not the terminal being received at the regular position upon the detector being be assembled to the housing,
the locking portion having an abutment part abutting against the terminal to lock the terminal, and an interference part interfering with the detector to prevent the detector from being assembled to the housing,
the abutment part being displaced to abut against the terminal to lock the terminal at the regular position upon the terminal being at the regular position, and to leave the terminal upon the terminal not being at the regular position,
the interference part moving along with a displacement of the abutment part and being configured to be displaced at a position not to interfere with the detector upon the terminal being at the regular position, and to be displaced to a position to interfere with the detector upon the terminal not being at the regular position.

2. The connector according to claim 1, wherein
the housing has a plurality of the terminal housing chambers; and
the locking portion provided in at least one of the terminal housing chambers has the interference part.

3. The connector according to claim 1, wherein
the locking portion has a double-supported-beam-shaped elastically deformable support part extending in a direction to a terminal housing direction and the abutment part and the interference part disposed to move along with the support part.

4. The connector according to claim 1, wherein
the housing has a plurality of the terminal housing chambers,
the connector further comprises a short-circuit terminal configured to contact two or more the terminals housed in two or more of the plurality of terminal housing chambers to electrically short the two or more the terminals,
the locking portion each provided in the two or more of the terminal housing chambers has the abutment part and the interference part.

5. A wire harness comprising:
the connector according to claim 1; and
an electric wire configured to have the terminal housed in the terminal housing chamber.
